(19) United States
(12) Patent Application Publication
(10) Pub. No.: US 2007/0236863 A1
(43) Pub. Date: Oct. 11, 2007

(54) Capacitors and methods of fabricating the same

(75) Inventors: Jong-cheol Lee, Seoul (KR); Young-sun Kim, Suwon-si (KR); Jung-hee Chung, Suwon-si (KR); Kyoung-ryul Yoon, Goyang-si (KR); Ki-vin Im, Suwon-si (KR); Jae-hyoung Choi, Hwaseong-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/486,065

(22) Filed: Jul. 14, 2006

(30) Foreign Application Priority Data
Aug. 16, 2005 (KR) 10-2005-0074915

(51) Int. Cl. H01G 4/06; H01G 7/00

(52) U.S. Cl. 361/313; 29/25.42; 361/311

(57) ABSTRACT

A capacitor may have a pre-treatment layer formed on a lower electrode, reaction to a dielectric layer and/or deterioration of capacitor characteristics may be suppressed. At least part of the dielectric layer may be oxidized or nitridized after being oxidized, and increases in leakage current may be suppressed. In a method of fabricating a capacitor, a plasma treatment performed before and after the forming of the dielectric layer within the batch-type equipment may cause retention time between the plasma treatment and the deposition of the dielectric layer to be the same or substantially the same for each wafer and/or capacitors may show smaller variations in layer characteristics between wafers.

### PRIORITY STATEMENT

This application claims priority under 35 U.S.C. §119 to Korean Patent Application No. 10-2005-0074915, filed on Aug. 16, 2005, in the Korean Intellectual Property Office (KIPO), the entire contents of which are incorporated herein by reference.

### BACKGROUND

1. Field of the Invention

Example embodiments of the present invention relate to semiconductor devices, for example, dynamic random access memory (DRAM) cell capacitors usable in higher-integrated devices, and methods of fabricating the same.

2. Description of the Related Art

As semiconductor devices such as DRAMs become increasingly integrated, cell size and/or effective area of a lower electrode of a cell capacitor may be reduced. However, a given cell capacitance may still be needed for to maintain stable operation. To secure higher cell capacitance in a smaller area, a higher dielectric layer made of a material such as Al₂O₃, HfO₂, Ta₂O₅, TiO₂ or the like should be used. The higher dielectric materials may have a dielectric constant greater than (e.g., several times to hundreds of times greater than), for example, an oxide layer/nitride layer/oxide layer (ONO) used for related art dielectric layers.

Doped polysilicon used for related art capacitor electrode material may react with the above-mentioned higher dielectric layer materials and deteriorate electrical characteristics of the capacitor. One example of an electrode material having improved oxidation resistance is a metal nitride such as TiN, TaN, WN or the like. However, when using a metal nitride electrode, a lower dielectric layer having a lower dielectric constant is formed between a lower electrode and the dielectric layer. In this example, and a plasma nitridation treatment must be performed on the lower electrode. Because the plasma nitridation treatment is performed by a single-type equipment, retention time until a batch-type dielectric layer deposition equipment delivers a wafer and begins deposition of a dielectric layer may vary for each wafer. This may result in a larger variation in layer characteristics.

In addition, higher-dielectric layers may produce leakage current originating from oxygen vacancies generated due to shortage of oxygen atoms. A plasma oxidation treatment may be performed to suppress the leakage current. Because the plasma oxidation treatment is performed by a single-type equipment, retention time until a batch-type dielectric layer deposition equipment delivers a wafer and begins the plasma oxidation treatment may also vary for each wafer. This may also result in a larger variation in layer characteristics.

When the single-type equipment performs the plasma nitridation treatment and the plasma oxidation treatment, the number of wafers that may be processed concurrently or simultaneously may be limited, may reduce productivity and/or may be more difficult to be applied to mass production.

### SUMMARY OF THE INVENTION

At least some example embodiments of the present invention provide capacitors capable of suppressing an increase of a leakage current and/or applicable to a more highly integrated DRAM. At least some example embodiments of the present invention present invention provide methods of fabricating a capacitor with smaller variations in layer characteristics.

According to an example embodiment of the present invention, a capacitor may include a lower electrode formed on a semiconductor substrate. A pre-treatment layer of a nitride-based material or layers of nitride based material may be formed on the lower electrode. A dielectric layer may be formed on the pre-treatment layer. At least part of the dielectric layer may be oxidized and/or nitridized after being oxidized. An upper electrode may be formed on the dielectric layer.

According to another example embodiment of the present invention, a capacitor may include a lower electrode formed on a semiconductor substrate. A pre-treatment layer of a nitride-based material or layers of nitride based material may be formed on the lower electrode. A first dielectric layer may be formed on the pre-treatment layer, and an oxygen diffusion barrier layer may be formed on the first dielectric layer. A second dielectric layer may be formed on the oxygen diffusion barrier layer. At least part of the second dielectric layer may be oxidized and/or nitridized after being oxidized. An upper electrode may be formed on the second dielectric layer.

According to another example embodiment of the present invention, a lower electrode may be formed on a semiconductor substrate. The lower electrode and the semiconductor substrate may be batch processed (e.g., at a batch-type equipment). The batch processing may include forming a pre-treatment layer on the lower electrode using a first plasma treatment, forming a dielectric layer on the pre-treatment layer using, for example, an atomic layer deposition (ALD) and oxidizing and/or nitridizing at least part of the dielectric layer using a second plasma treatment. An upper electrode may be formed on the dielectric layer.

In another example embodiment of the present invention, a lower electrode may be formed on a semiconductor substrate. The lower electrode and the semiconductor substrate may be batch processed (e.g., at a batch-type equipment). The batch processing may include forming a pre-treatment layer on the lower electrode using a first plasma treatment, forming a first dielectric layer on the pre-treatment layer using, for example, an atomic layer deposition (ALD), forming an oxygen diffusion barrier layer on the first dielectric layer, forming a second dielectric layer on the oxygen diffusion barrier layer and oxidizing and/or nitridizing at least part of the second dielectric layer using a second plasma treatment. An upper electrode may be formed on the second dielectric layer.

In at least some example embodiments of the present invention, the lower electrode and/or the upper electrode may be comprised of metal layers, conductive metal nitride layers or the like. The dielectric layers may be comprised of an HfO₂ layer, an Al₂O₃ layer, a ZrO₂ layer, a TiO₂ layer, a combination thereof or the like. The oxygen diffusion barrier layer may be comprised of a material different from at least one of the dielectric layers. The oxygen diffusion barrier layer may be comprised of AlN, Al₂O₃, SiO₂, Si₃N₄, a combination thereof or a nitride oxide layer formed using a plasma nitridation treatment. The first plasma treatment may be performed using N₂, NH₃, H₂, a combination thereof or the like, at a temperature of about 300° C. to about 500° C., inclusive.

In at least some example embodiments of the present invention, a power used for generating a plasma may be about 500W to about 1000W, inclusive, a process pressure may be about 1 Pa to about 200 Pa, inclusive and/or a process time may be about 30 minutes to about 90 minutes, inclusive. The second plasma treatment may be performed using N2, NH3, O2, a combination thereof of the like, at a temperature range of about 20° C. to about 300° C., inclusive. The power used for generating plasma may be about 500W to about 1000W, inclusive, a process pressure may be about 1 Pa to about 200 Pa, inclusive, and a process time may e about 30 minutes to about 90 minutes, inclusive.

### BRIEF DESCRIPTION OF THE DRAWINGS

The present invention will become more apparent by describing in detail the example embodiments shown in the attached drawings in which:

FIGS. 1 through 8 illustrate a method of fabricating a capacitor according to an example embodiment of the present invention;

FIGS. 9 through 13 illustrate a method of fabricating a capacitor according to another example embodiment of the present invention; and

FIG. 14 is a graph illustrating a characteristic of a leakage current with respect to a voltage in a capacitor according to at least one example embodiment of the present invention.

### DETAILED DESCRIPTION OF EXAMPLE EMBODIMENTS OF THE PRESENT INVENTION

Various example embodiments of the present invention will now be described more fully with reference to the accompanying drawings in which some example embodiments of the invention are shown. In the drawings, the thicknesses of layers and regions are exaggerated for clarity.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element or layer is referred to as being “formed on” another element or layer, it can be directly or indirectly formed on the other element or layer. That is, for example, intervening elements or layers may be present. In contrast, when an element or layer is referred to as being “directly formed on” to another element, there are no intervening elements or layers present. Other words used to describe the relationship between elements or layers should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the FIGS. For example, two FIGS. shown in succession may in fact be executed substantially concurrently or may sometimes be executed in the reverse order, depending upon the functionality/acts involved.

FIGS. 1 through 8 illustrate a method of fabricating a capacitor according to an example embodiment of the present invention.

Referring to FIG. 8, a capacitor, according to an example embodiment of the present invention, may include a lower electrode 140a formed on a semiconductor substrate 100, a pretreatment layer 148, a dielectric layer 150′ and/or an upper electrode 180. The pre-treatment layer 148 may be comprised of a nitride-based material, layer or layers and may be formed on the lower electrode 140a. The dielectric layer 150′ may be formed on the pre-treatment layer 148. At least part of the dielectric layer 150′ may be oxidized or nitridized after being oxidized. The upper electrode 180 may be formed on the dielectric layer 150′.

The lower electrode 140a may be a metal layer, a conductive metal nitride layer or the like, and the pre-treatment layer 148 may be a nitride layer, or similar layer, formed by plasma treatment or any other suitable method. The dielectric layer 150′ may be, for example, an HfO₂ layer, an Al₂O₃ layer, a ZrO₂ layer, a TiO₂ layer, a combination thereof or the like. The upper electrode 180 may be a metal layer, a conductive metal nitride layer or the like.

In at least some example embodiments of the present invention, the pre-treatment layer 148 formed on the lower electrode 140a may suppress a reaction with the dielectric layer 150′ and/or deterioration of the capacitor characteristics. Because at least part of the dielectric layer 150′ may be oxidized or nitridized, increases in leakage current may be suppressed and the capacitor may be applied to a more highly integrated semiconductor devices such as DRAMs or the like.

FIGS. 1-7 illustrate a method of fabricating a capacitor according to an example embodiment of the present invention. In this example embodiment, a capacitor lower electrode may be formed on a semiconductor substrate such as a silicon substrate or the like. To increase an effective area of the lower electrode, the lower electrode may be formed in a three-dimensional structure (e.g., a box structure, one cylinder stack (OCS) structure, a stack structure, a trench structure or any other suitable structure). The example embodiment of the present invention as shown in FIGS. 1-8 are discussed herein with regard to the OCS structure, however, example embodiments of the present invention may be readily applied to any other suitable structure.

Referring to FIG. 1, a lower insulation layer 110 may be formed on the semiconductor substrate 100. A contact plug 115 may be formed to pass through the lower insulation layer 110 and contact an impurity region 105 of the semiconductor substrate 100. An etch-stop layer 120 may be formed on the contact plug 115 and the lower insulation layer 110. A mold oxide layer 130 may be formed on the etch-stop layer 120. The etch-stop layer 120 may be comprised of, for example, a silicon nitride layer or the like. The mold oxide layer 130 may comprise boron phosphorus silicate glass (BPSG), phosphorus silicate glass (PSG), plasma enhanced (PE)-tetra ethyl ortho silicate (TEOS), high density plasma (HDP)-oxide or the like.

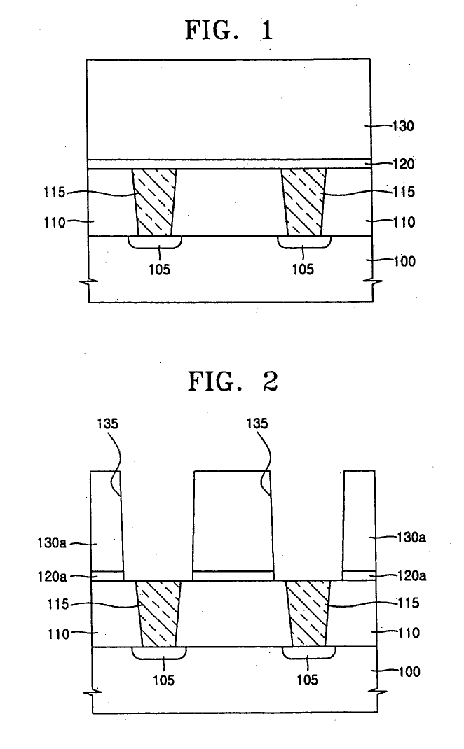

Referring to FIG. 2, the mold oxide layer 130 may be etched until the upper surface of the etch-stop layer 120 is exposed, forming a mold oxide layer pattern 130a. The etch-stop layer 120 may protect the lower insulation layer 110 so that the lower insulation layer 110 may not be etched. An etching process may be performed to remove the exposed etch-stop layer 120 and form a hole 135 exposing the contact plug 115 and the upper surface of the lower insulation layer 110 in the neighborhood of the contact plug 115. An etch-stop layer pattern 120a may remain at the lower portion of the mold oxide layer pattern 130a.

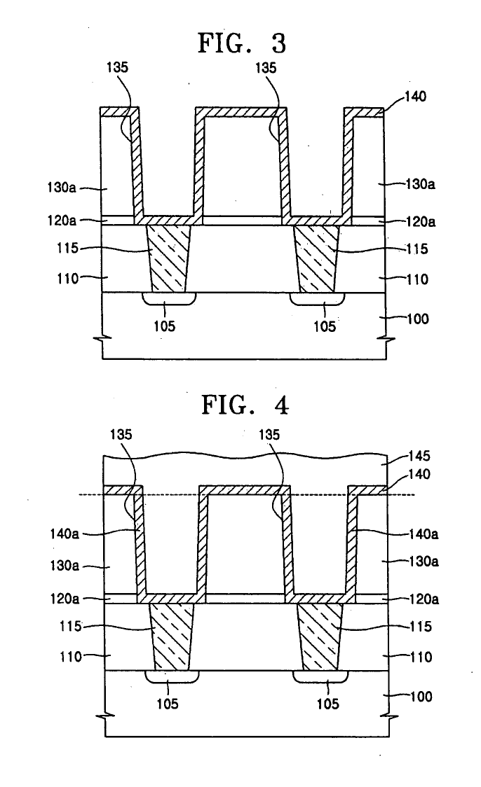

Referring to FIG. 3, a lower electrode layer 140 having a given thickness may be formed so that the hole 135 is partially filled (e.g., not filled completely). The lower electrode layer 140 may comprise a metal layer, a conductive metal nitride layer (e.g., a TiN layer, a WN layer, a TaN layer or a combination thereof) or the like. Such a layer may be formed using a chemical vapor deposition (CVD), atomic layer deposition (ALD), a metal organic CVD (MOCVD) or any other suitable deposition method.

Referring to FIG. 4, a capping layer 145 (e.g., undoped silicate glass (USG) or the like) having suitable gap-fill characteristics may be deposited on the lower electrode layer 140 to fill the inside of the hole 135. The capping layer 145 and the lower electrode layer 140 (e.g., the portion above a dotted line in FIG. 4) may be removed until the upper surface of the mold oxide layer pattern 130a is exposed. The capping layer 145 and the lower electrode layer 140 may be removed using an etch-back, chemical mechanical polishing (CMP) or any other suitable removal process. By doing so, cylinder type-capacitor lower electrodes 140a may be formed.

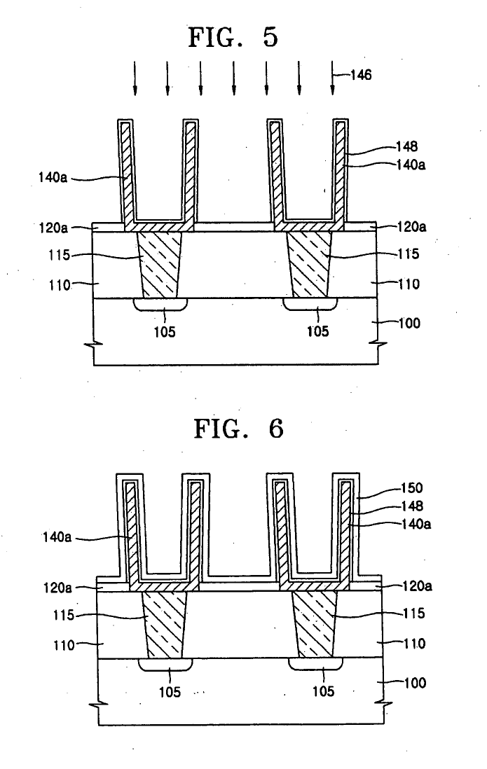

Referring to FIG. 5, the capping layer 145 and the mold oxide layer pattern 130a may be removed to expose the surface of the lower electrode 140a. The capping layer 145 and the mold oxide layer 130a may be removed using, for example, wet-etching or any other suitable removal method. A first plasma treatment 146 may be performed for the lower electrode 140a using a batch-type equipment, forming a pre-treatment layer 148 on the lower electrode 140a. The first plasma treatment 146 may be a plasma nitridation treatment or any other suitable plasma treatment method. For example, the first plasma treatment 146 may be performed using N₂, NH₃, H₂, a combination thereof or any other suitable gas. The first plasma treatment 146 may be performed at a temperature range of about 300° C. to about 500° C., inclusive. In the first plasma treatment 146, an radio frequency (RF) power used to generate plasma may be about 500W to about 1000W, inclusive, a process pressure may be about 1 Pa to about 200 Pa, inclusive, and/or a process time may be about 30 minutes to about 90 minutes, inclusive.

For example, the plasma nitridation treatment using gas NH₃ may be performed on the surface of the lower electrode 140a. In doing so, the pre-treatment layer 148 of a nitride-based material or layers of material may be formed on the surface of the lower electrode 140a. The pre-treatment layer 148 may suppress and/or prevent potential reaction between the lower electrode 140a and a dielectric layer. As described above, because the first plasma treatment 146 may be performed by the batch-type equipment, at least some example embodiments of the present invention may have improved productivity, be more efficiently and/or more appropriately applied to mass production as compared to related art plasma nitridation treatment using single-type equipment.

Referring to FIG. 6, a dielectric layer 150 may be formed on the pre-treatment layer 148 continuously with the forming of the pre-treatment layer 148 at the batch-type equipment. The dielectric layer 150 may be formed using ALD or any other suitable deposition method. The dielectric layer 150 may be comprised of, for example, an HfO₂ layer, an Al₂O₃ layer, a ZrO₂ layer, a TiO₂ layer, a combination thereof or the like. Because a lower deposition temperature may be maintained (e.g., around about 300° C. in the case of the ALD), the ALD may be advantageous in terms of process temperature.

For example, after the first plasma treatment 146 is performed using the batch-type equipment, a process of forming the dielectric layer 150 may be performed using the same batch-type equipment. This may suppress and/or prevent the possibility that retention time consumed after the plasma treatment 146 and before the deposition of the dielectric layer 150 varies and/or changes for each wafer. As a result, variations in layer characteristics for each wafer may be reduced.

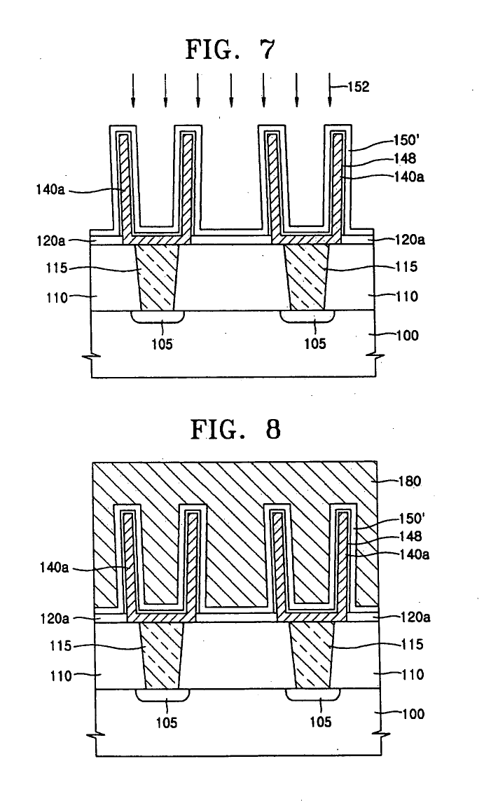

Referring to FIG. 7, the second plasma treatment 152 may be performed using the batch-type equipment to oxidize and/or nitridize after oxidizing at least part of the dielectric layer 150. By doing so, a dielectric layer 150′, at least part of which may be oxidized or nitridized after being oxidized, may be formed. The second plasma treatment 152 may be performed using N₂, NH₃, O₂, a combination thereof or any other suitable gas. The second plasma treatment 152 may be performed in temperature range of about room temperature (e.g., about 20° C.) to about 300° C., inclusive. Gas comprising, for example, N₂ or O₂ may be used for oxidation, and gas comprising, for example, N₂ and NH₃ may be used for nitridation. When the second plasma treatment 152 is performed, an RF power used to generate plasma may be about 500W to about 1000W, inclusive, a process pressure may be about 1 Pa to about 200 Pa, inclusive, and/or a process time may be about 30 minutes to about 90 minutes, inclusive. For example, the second plasma treatment 152 may be performed under the temperature range of about 150° C. to about 300° C., inclusive and/or a process pressure range of about 100 Pa to about 200 Pa, inclusive. The electrical characteristic of the dielectric layer 150′ may be improved using the second plasma treatment 152.

Performing the second plasma treatment 152 within the same batch-type equipment that has performed the process of forming the dielectric layer 150 may suppress the possibility that retention time from after the dielectric layer 150 is formed until the second plasma treatment 152 is performed may vary and/or be changed for each wafer. This may reduce variations in layer characteristics for each wafer.

Referring to FIG. 8, an upper electrode 180 may be formed on the dielectric layer 150′, at least part of which may be oxidized or nitridized after being oxidized. The upper electrode 180 may be formed of a metal layer, a conductive metal nitride layer or the like.

As described above, in at least some methods of fabricating the capacitor according to example embodiments of the present invention, the first plasma treatment 146, the forming of the dielectric layer 150 and the second plasma treatment 152 may be performed (e.g., continuously) within the batch-type equipment, and potential variations and/or changes in retention time after the first plasma treatment 146 until the deposition of the dielectric layer 150, and after forming the dielectric layer 150 until the second plasma treatment 152 is performed may be suppressed. Therefore, it may be possible to fabricate a capacitor having smaller variations in layer characteristics for each wafer and/or variations between wafers due to aging may be reduced.

At least some example embodiments of the present invention may also provide leakage current improvements that are the same or substantially the same as in plasma treatment using single-type equipment. Because the batch-type equipment is used, a mass amount of wafers (e.g., one hundred, one thousand, etc.) may be processed concurrently or simultaneously. In doing so, productivity may improve.

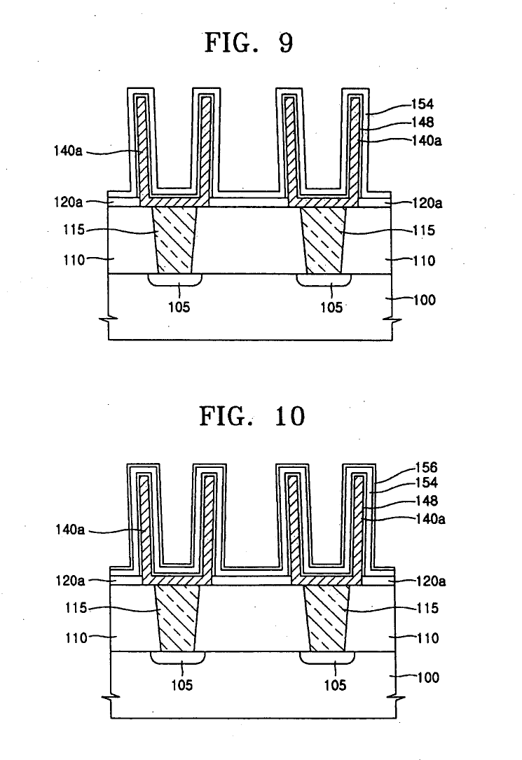

FIGS. 9 through 13 illustrate a method of fabricating a capacitor of a semiconductor device according to another example embodiment of the present invention. In FIGS. 9 through 13, the same reference numerals as those used to describe the example embodiment of FIGS. 1-8 are used.

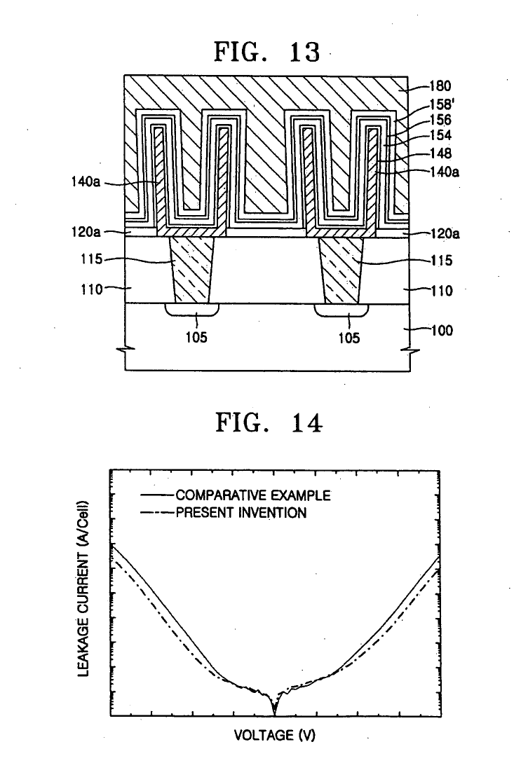

Referring to FIG. 13, a capacitor according to another example embodiment of the present invention may include a capacitor lower electrode 140a formed on a semiconductor substrate 100, a pre-treatment layer 148 formed on the lower electrode 140a, a first dielectric layer 154 formed on the pre-treatment layer 148, an oxygen diffusion barrier layer 156 formed on the first dielectric layer 154, a second dielectric layer 158′ formed on the oxygen diffusion barrier layer 156 and/or an upper electrode 180 formed on the second dielectric layer 158′. The pre-treatment layer 148 may be comprised of a nitride-based material or layers of materials. At least part of the second dielectric layer 158′ may be oxidized or nitridized after being oxidized.

The first and second dielectric layers 154 and 158′ may be comprised of, for example, an HfO₂ layer, an Al₂O₃ layer, a ZrO₂ layer, a TiO₂ layer, a combination thereof or the like. The oxygen diffusion barrier layer 156 may be a material different from the first and second dielectric layers 154 and 158′. For example, the oxygen diffusion barrier layer 156 may be comprised of AlN, Al₂O₃, SiO₂, Si₃N₄, a combination thereof or the like. In another example, the oxygen diffusion barrier layer 156 may be, for example, a nitride oxide layer or the like formed using a plasma nitridation treatment.

As described above, because the capacitor, according to at lease some example embodiments of the present invention, may have the pre-treatment layer 148 on the lower electrode 140a, reaction to dielectric layers (e.g., the first and second dielectric layers 154 and 158′) may be suppressed and deterioration of capacitor characteristics may be reduced and/or prevented. Additionally, because at least part of the second dielectric layer 158′ may be oxidized or nitridized after being oxidized, increases in leakage current may be suppressed and example embodiments of the present invention may be applied to more highly integrated semiconductor devices such as DRAMs or the like. The oxygen diffusion barrier layer 156 may be provided to suppress oxidation of the lower electrode 140a.

A method of fabricating the above-described capacitor according to an example embodiment of the present invention will be described.

In this example embodiment, operations or processes described with reference to FIGS. 1 through 5 may be performed to form the capacitor lower electrode 140a on the semiconductor substrate 100 as illustrated in FIG. 9. The pre-treatment layer 148 may be formed on the lower electrode 140a. The batch-type equipment used in the first plasma treatment (e.g., 146 of FIG. 5) may form the first dielectric layer 154 on the pre-treatment layer 148 using, for example, an ALD continuously with the forming the pre-treatment layer 148. The first dielectric layer 154 may be comprised of an HfO₂ layer, an Al₂O₃ layer, a ZrO₂ layer, a TiO₂ layer, a combination thereof or the like.

Similar to the example embodiment as shown in FIGS. 1-8, the process of forming the first dielectric layer 154 may be performed by the same batch-type equipment that performed the first plasma treatment 146 so that the potential for variations and/or changes in retention time from after the first plasma treatment 146 until the deposition of the first dielectric layer 154 for each wafer may be suppressed. In doing so, variations in layer characteristics for each wafer may be reduced.

Referring to FIG. 10, the batch-type equipment may form an oxygen diffusion barrier layer 156 on the first dielectric layer 154 continuously with the forming of the first dielectric layer 154. The oxygen diffusion barrier layer 156 may be formed of a material different from the first dielectric layer 154 using, for example, an ALD or any other suitable deposition process. For example, the oxygen diffusion barrier layer 156 may be comprised of AlN, Al₂O₃, SiO₂, Si₃N₄, a combination thereof or the like. The oxygen diffusion barrier layer 156 may also be formed of a nitride oxide layer using a plasma nitridation treatment by the batch-type equipment continuously with the forming of the first dielectric layer 154.

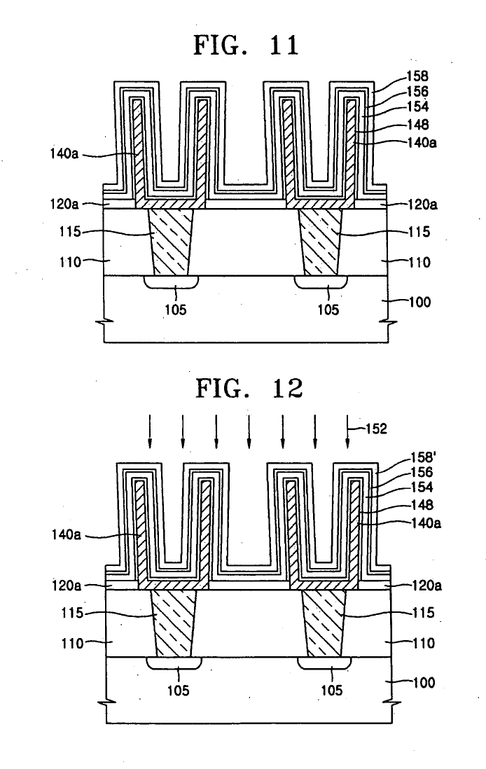

Referring to FIG. 11, the above-used batch-type equipment may form the second dielectric layer 158 on the oxygen diffusion barrier layer 156 using, for example, an ALD or the like continuously with the forming of the oxygen diffusion barrier layer 156. The second dielectric layer 158 may be comprised of an HfO₂ layer, an Al₂O₃ layer, a ZrO₂ layer, a TiO₂ layer, a combination thereof or the like, which may be different from the material of the oxygen diffusion barrier layer 156.

Referring to FIG. 12, the above-used batch-type equipment may perform the second plasma treatment 152 so as to oxidize at least part of the dielectric layer 158 or nitridize at least part of the dielectric layer 158 after oxidizing the same. By doing so, the second dielectric layer 158′ may be formed. The conditions of the second plasma treatment 152 may be the same or substantially the same as those described above with regard to FIGS. 1-8.

According to at least some example embodiments of the present invention, because the second plasma treatment 152 is performed within the batch-type equipment, variations and/or changes in retention time after the second dielectric layer 158 is formed until the second plasma treatment 152 begins may be suppressed and/or variations in layer characteristics for each wafer may be reduced.

Referring to FIG. 13, an upper electrode 180 may be formed on the second dielectric layer 158′, at least part of which may be oxidized or nitridized after being oxidized.

As described above, according to at least some example embodiments of the present invention, because the first plasma treatment 146, the forming of the first dielectric layer 154, the forming of the oxygen diffusion barrier layer 156, the forming of the second dielectric layer 158 and/or the second plasma treatment 152 are performed continuously within the batch-type equipment, the retention time after the first plasma treatment 146 until the deposition of the first dielectric layer 154 begins may not vary or change between wafers. In addition, the retention time after the forming of the second dielectric layer 158 until the second plasma treatment begins may not vary or change between wafers. This may result in capacitors having smaller variations in layer characteristics from wafer to wafer. Also, using the batch-type equipment may improve productivity. Forming the oxygen diffusion barrier layer 156 may suppress, reduce and/or prevent oxidation of the lower electrode 140a due to oxygen diffusion.

Example embodiments of the present invention will now be described with reference to the following experimental examples. However, the following experimental examples are solely for example purposes and do not limit the present invention.

Experiment 1

As in the example embodiment of the present invention shown in FIGS. 9-13, the capacitor has been fabricated by forming of the lower electrode; forming the pre-treatment layer by performing, at the batch-type equipment, the first plasma treatment; forming the first dielectric layer; forming the oxygen diffusion barrier layer; forming the second dielectric layer; performing, at the batch-type equipment, the second plasma treatment; and forming the upper electrode. After fabricating a capacitor, a leakage current characteristic may be measured.

FIG. 14 is a graph illustrating a characteristic (a dash-dot line) of a leakage current with respect to a voltage V in a capacitor according to an example embodiment of the present invention. For comparison purposes, the case where the plasma treatment is not performed before and after forming the dielectric layer is also illustrated.

Referring to FIG. 14, when the batch-type equipment performs the plasma treatment before and after forming the dielectric layer according to example embodiments of the present invention, a capacitor having equivalent capacitance may have improved leakage current characteristics as compared to the related art case where the plasma treatment is not performed.

Process conditions of the first and second plasma treatments adopted herein are shown in the following Tables 1 and 2.

TABLE 1

| | | Process | RF power | Process | Process time |
|---|---|---|---|---|---|
| Gas in use | | pressure (Pa) | (W) | temperature (° C.) | (minute) |
| N₂ | NH₃ | 1-200 | 500-1000 | 300-500 | 30-90 |

TABLE 2

| | | | | | | Process |
|---|---|---|---|---|---|---|
| | | | Process | RF power | Process | time |
| Gas in use | | | pressure (Pa) | (W) | temperature (° C.) | (minute) |
| N₂ | NH₃ | O₂ | 1-200 | 500-1000 | Room | 30-90 |
| | | | | | temperature-300 | |

Because the capacitor according to example embodiments of the present invention has the pre-treatment layer formed on the lower electrode, reaction to the dielectric layer may be suppressed and/or deterioration of the capacitor's characteristics may be reduced, suppressed and/or prevented. Also, because at least part of the dielectric layer has oxidized or nitridized after being oxidized, an increase in leakage current may be suppressed and the capacitor may be applied to more highly integrated semiconductor devices, such as, DRAMs or the like.

Experiment 2

A wafer plasma-oxidized by the single-type equipment as a post process for a dielectric layer in a process set up of the related art is prepared and a wafer plasma-oxidized by the batch-type equipment according to at least one example embodiment of the present invention may be prepared. A comparison has been made for a leakage current characteristic and a Toxeq. As a result of comparison, example embodiments of the present invention are shown to have the same or substantially the same leakage current reduction and/or the same or substantially the same Toxeq as in the plasma treatment using the single-type equipment. For example, the conditions used herein are as follows: a process pressure is 100-200 Pa, power is 500-1000W, a process time is 30-90 minutes and a process temperature is 150-350° C. in the case where the uppermost layer of the dielectric layer to which the plasma oxidation is applied is HfO₂.

In the method of fabricating the capacitor according to at least one example embodiment of the present invention, because the plasma treatment before and after the forming of the dielectric layer is performed within the batch-type equipment continuously with the forming of the dielectric layer, the retention time between the plasma treatment and the deposition of the dielectric layer may not vary, be changed for each wafer and/or a capacitor showing smaller variations in layer characteristics for each wafer may be fabricated. In doing so, variations between wafers due to aging may be reduced.

Example embodiments of the present invention may achieve the same or substantially the same reduction in leakage currents as in the related art plasma treatment using the single-type equipment. In addition, because the batch-type equipment is used, mass amounts of wafers (e.g., one hundred, one thousand, etc.) may be processed concurrently or simultaneously which may improve productivity. As discussed herein, batch processing may refer to processes and or functions performed within the batch-type equipment.

While example embodiments of the present invention have been particularly shown and described with reference to the example embodiments shown in the drawings, it will be understood by those of ordinary skill in the art that various changes in form and details may be made therein without departing from the spirit and scope of the present invention as defined by the following claims.

What is claimed is:

1. A capacitor comprising:
a lower electrode formed on a semiconductor substrate;
a nitride pre-treatment layer formed on the lower electrode;
at least one dielectric layer, one of the at least one dielectric layers being formed on the pre-treatment layer and at least part of one of the at least one dielectric layers being oxidized or nitridized; and
an upper electrode formed on the at least one dielectric layer.

2. The capacitor of claim 1, wherein the at least one dielectric layer includes a single dielectric layer formed on the pretreatment layer and at least part of which is oxidized or nitridized.

3. The capacitor of claim 2, wherein the lower electrode and the upper electrode are metal layers or conductive metal nitride layers.

4. The capacitor of claim 2, wherein the dielectric layer is comprised of an HfO₂ layer, an Al₂O₃ layer, a ZrO₂ layer, a TiO₂ layer or a combination thereof.

5. The capacitor of claim 1, wherein the at least one dielectric layer further includes a first dielectric layer and a second dielectric layer, and
the first dielectric layer is formed on the pre-treatment layer,
an oxygen diffusion barrier layer is formed on the first dielectric layer, and
the second dielectric layer is formed on the oxygen diffusion barrier layer, at least part of the second dielectric layer being oxidized or nitridized.

6. The capacitor of claim 5, wherein the lower electrode and the upper electrode are metal layers or conductive metal nitride layers.

7. The capacitor of claim 5, wherein the first and second dielectric layers are comprised of an HfO₂ layer, an Al₂O₃ layer, a ZrO₂ layer, a TiO₂ layer or a combination thereof.

8. The capacitor of claim 5, wherein the oxygen diffusion barrier layer is comprised of a material different from at least one of the first and second dielectric layers.

9. The capacitor of claim 5, wherein the oxygen diffusion barrier layer is comprised of AlN, Al₂O₃, SiO₂, Si₃N₄ or a combination thereof.

10. The capacitor of claim 5, wherein the oxygen diffusion barrier layer is a nitride oxide layer formed using a plasma nitridation treatment.

11. A method of fabricating a capacitor, the method comprising:
forming a lower electrode on a semiconductor substrate;
batch processing the lower electrode and the semiconductor substrate, the batch processing including,
forming a pre-treatment layer on the lower electrode using a first plasma treatment,
forming at least one dielectric layer on the pre-treatment layer using atomic layer deposition (ALD), and
at least one of oxidizing and nitridizing at least part of the at least one dielectric layer using a second plasma treatment; and
forming an upper electrode on the dielectric layer, at least part of the upper electrode being oxidized or nitridized.

12. The method of claim 11, wherein the at least one dielectric layer includes a single dielectric layer, the single dielectric layer being formed on the pre-treatment layer, and at least part of the single dielectric layer being at least one of oxidized or nitridized.

13. The method of claim 12, wherein the lower electrode and the upper electrode are formed of metal layers or conductive metal nitride layers.

14. The method of claim 12, wherein the first plasma treatment is performed using N₂, NH₃, H₂ or a combination thereof at a temperature of about 300° C. to about 500° C., inclusive.

15. The method of claim 12, wherein in the first plasma treatment, an RF (radio frequency) power used for generating a plasma is about 500W to about 1000W, inclusive, a process pressure is about 1 Pa to about 200 Pa, inclusive and a process time is about 30 minutes to about 90 minutes, inclusive.

16. The method of claim 12, wherein the second plasma treatment is performed using N₂, NH₃, O₂ or a combination thereof at a temperature range of about 20° C. to about 300° C., inclusive.

17. The method of claim 12, wherein in the second plasma treatment, a radio frequency power used for generating a plasma is 500W to about 1000W, inclusive, a process pressure is about 1 Pa to about 200 Pa, inclusive and a process time is about 30 minutes to about 90 minutes, inclusive.

18. The method of claim 12, wherein the at least one dielectric layer is comprised of an HfO₂ layer, an Al₂O₃ layer, a ZrO₂ layer, a TiO₂ layer or a combination thereof.

19. The method of claim 11, wherein the forming the at least one dielectric layer further includes,
forming a first dielectric layer on the pre-treatment layer using atomic layer deposition (ALD),
forming an oxygen diffusion barrier layer on the first dielectric layer, and
forming a second dielectric layer on the oxygen diffusion barrier layer, wherein
the performing of the second plasma treatment oxidizes or nitridizes at least part of the second dielectric layer.

20. The method of claim 19, wherein the lower electrode and the upper electrode are metal layers or conductive metal nitride layers.

21. The method of claim 19, wherein the first plasma treatment is performed at a temperature of about 300° C. to about 500° C., inclusive, using gas selected from the group consisting of N₂, NH₃, H₂ and a mixture thereof.

22. The method of claim 19, wherein the first plasma treatment is performed at an RF power of about 500W to about 1000W, inclusive, and a pressure of about 1 Pa to about 200 Pa for about 30 minutes to about 90 minutes, inclusive.

23. The method of claim 19, wherein the second plasma treatment is performed at a temperature from about 20° C. to about 300° C., inclusive, using a gas selected from the group consisting of N₂, NH₃, O₂ and a mixture thereof.

24. The method of claim 19, wherein the second plasma treatment is performed at a radio frequency power of about 500W to about 1000W, inclusive and a pressure of about 1 Pa to about 200 Pa for about 30 minutes to about 90 minutes, inclusive.

25. The method of claim 19, wherein the first and second dielectric layers are comprised of an HfO₂ layer, an Al₂O₃ layer, a ZrO₂ layer, a TiO₂ layer or a combination thereof.

26. The method of claim 19, wherein the oxygen diffusion barrier layer is formed of a material different from at least one of the first and second dielectric layers using an ALD (atomic layer deposition).

27. The method of claim 19, wherein the oxygen diffusion barrier layer is comprises AlN, Al₂O₃, SiO₂, Si₃N₄ or a combination thereof.

28. The method of claim 19, wherein the oxygen diffusion barrier layer is formed of a nitride oxide layer using a plasma nitridation treatment.
